(19) United States
(12) Patent Application Publication
(10) Pub. No.: US 2012/0055912 A1
(43) Pub. Date: Mar. 8, 2012

(54) MICRO SPHERICAL STYLUS MANUFACTURING MACHINE

(75) Inventor: Dong-Yea Sheu, Taipei (TW)

(73) Assignee: NATIONAL TAIPEI UNIVERSITY OF TECHNOLOGY, Taipei (TW)

(21) Appl. No.: 12/876,340

(22) Filed: Sep. 7, 2010

(51) Int. Cl. H05B 1/00

(52) U.S. Cl. 219/201

(57) ABSTRACT

A micro spherical stylus manufacturing machine includes a three-axis moving unit movably disposed on a processing platform and connected to a single-pulse electrical monitoring unit; a detachable jig movably disposed on the moving unit for clamping a workpiece; a reeling and electrical discharging unit disposed on the processing platform and connected to the single-pulse electrical monitoring unit for processing the workpiece by electrical discharge machining (EDM) to form a pointed conical electrode instrument; an electrical discharging unit disposed on the processing platform and connected to the single-pulse electrical monitoring unit for processing the point of the workpiece by EDM to form a sphere; and an optical measuring unit disposed on the processing platform and connected to the single-pulse electrical monitoring unit for measuring the workpiece. Micro spherical styluses are manufactured and evaluated with the machine concurrently. Afterward, the machine turns into a coordinate measuring machine through the micro spherical styluses.

### FIELD OF THE TECHNOLOGY

The present invention relates to micro spherical stylus manufacturing machines, and more particularly, to a micro spherical stylus manufacturing machine capable of manufacturing a micro spherical stylus and evaluating the quality thereof concurrently and on-one-machine.

### BACKGROUND

A conventional micro coordinate measuring machine (CMM) cannot measure micro products, particularly micro parts and components of micro electro-mechanical systems (MEMS) manufactured in a semiconductor manufacturing process, because small sensing probes available in the market usually comes in a diameter larger than 0.2 mm; hence, the sensing probes cannot be used for measuring micro parts and components. To enable a micro coordinate measuring machine to measure micro parts and components precisely, it is necessary to manufacture a high-precision micro spherical stylus and attach the stylus to a micro coordinate measuring machine for measuring micro parts and components. Conventionally, a micro sphere made of ruby is adhered onto a front end of a vertical tool to form a micro spherical stylus, and the spherical stylus generally has a diameter of approximately 0.2 mm. Obviously, spherical styluses of a diameter less than 0.2 mm cannot be manufactured in accordance with the prior art.

Therefore, it is imperative to develop a spherical stylus manufacturing machine capable of fabricating a micro spherical stylus and evaluating the quality of the micro spherical stylus thus fabricated concurrently and on-one-machine.

### SUMMARY

In view of the foregoing shortcomings of the prior art, the inventor of the present invention conducted extensive researches and experiments based on the inventor's years of experience in the related industry, and finally developed a micro spherical stylus manufacturing machine, so as to manufacture and evaluate a micro spherical stylus concurrently and on-one-machine with the micro spherical stylus manufacturing machine, and turning the original micro spherical stylus manufacturing machine into a coordinate measuring machine by using the micro spherical stylus thus manufactured.

It is a primary objective of the present invention to provide a micro spherical stylus manufacturing machine including a reeling and electrical discharging unit, an electrical discharging unit and an optical measuring unit, such that a micro spherical stylus can be manufactured and evaluated concurrently and on-one-machine by the same electrical discharge machining (EDM) machine, and then the original EDM machine can be turned into a coordinate measuring machine by using the micro spherical stylus.

To achieve the foregoing and other objectives, the present invention provides a micro spherical stylus manufacturing machine, comprising: a single-pulse electrical monitoring unit; a processing platform; a three-axis moving platform movably disposed on the processing platform and electrically connected to the single-pulse electrical monitoring unit; a detachable jig movably disposed on the three-axis moving platform for clamping a micro tool; a reeling and electrical discharging unit disposed on the processing platform and electrically connected to the single-pulse electrical monitoring unit for processing the micro tool by electrical discharge machining (EDM) to thereby form a pointed conical electrode instrument; an electrical discharging unit disposed on the processing platform and electrically connected to the single-pulse electrical monitoring unit for processing the point of the micro tool by one-pulse electrical-discharge (OPED) to thereby form a sphere; and an optical measuring unit disposed on the processing platform and electrically connected to the single-pulse electrical monitoring unit for measuring the spherical stylus processed by the single-pulse electrical monitoring unit.

Therefore, with the micro spherical stylus manufacturing machine of the present invention, a micro spherical stylus can be concurrently manufactured and evaluated on-one-machine, and the original manufacturing machine can be turned into a coordinate measuring machine by using a commercially available probing head.

### BRIEF DESCRIPTION OF THE DRAWINGS

FIG. 1 is a perspective view of a preferred embodiment of the present invention;

FIG. 2 is a side view of a preferred embodiment of the present invention;

FIG. 3 is a schematic view of how to process a micro tool by electrical discharge machining (EDM), using a reeling and electrical discharging unit in a preferred embodiment of the present invention;

FIG. 4 is a schematic view of a micro tool processed by EDM through a reeling and electrical discharging unit in a preferred embodiment of the present invention;

FIG. 5 is a schematic view of how to process a sharp micro tool by EDM, using an electrical discharging unit in a preferred embodiment of the present invention;

FIG. 6 is a schematic view of the micro spherical stylus fabricated by a single-pulse electrical monitoring unit in a preferred embodiment of the present invention; and

FIG. 7 is a schematic view of an optical measuring unit measuring a micro spherical stylus in accordance with a preferred embodiment of the present invention.

### DETAILED DESCRIPTION

The objects, characteristics and effects of the present invention will become apparent with the detailed description of the preferred embodiments and the illustration of related drawings as follows.

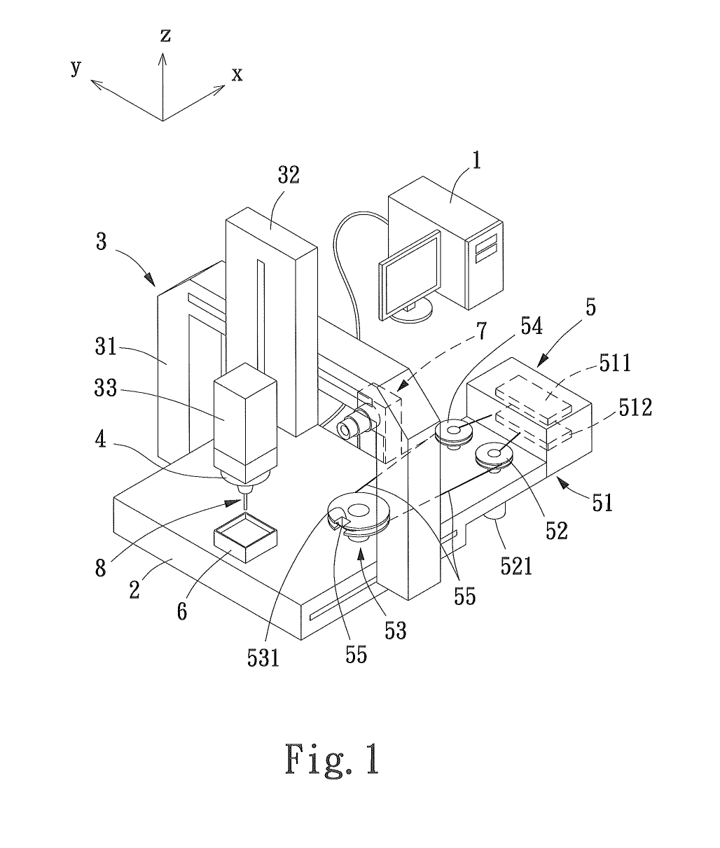

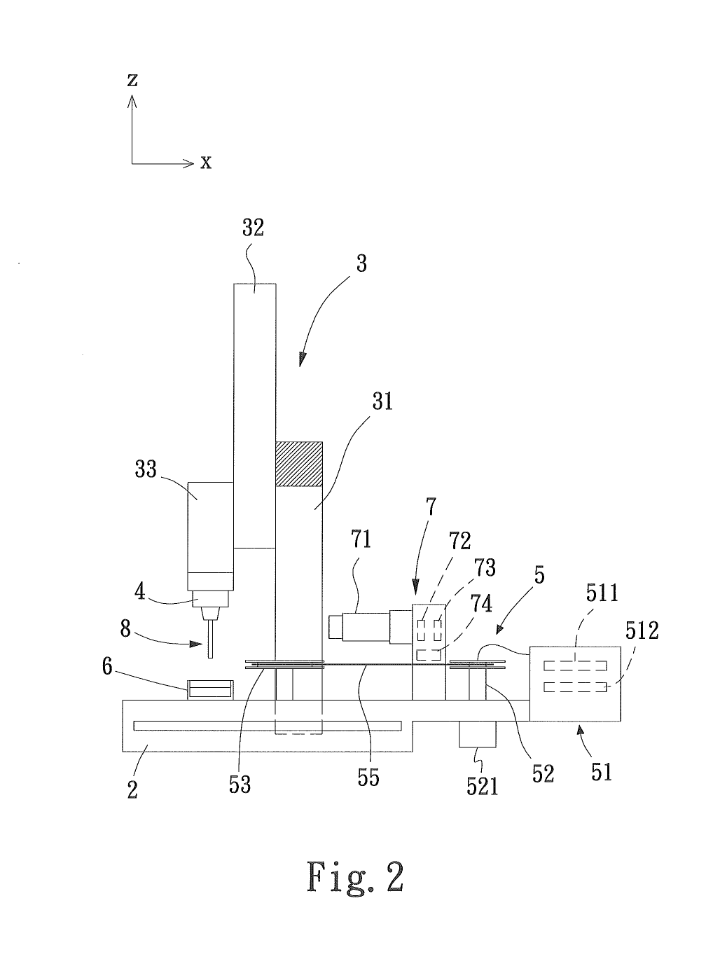

With reference to FIGS. 1 and 2 for a perspective view and a side view of a preferred embodiment of the present invention, respectively, a micro spherical stylus manufacturing machine of the present invention comprises a single-pulse electrical monitoring unit 1, a processing platform 2, a three-axis moving platform 3, a detachable jig 4, a reeling and electrical discharging unit 5, a single-pulse electrical discharging unit 6, and an optical measuring unit 7. The single-pulse electrical monitoring unit 1 is a desktop computer, a notebook computer, or a server. The three-axis moving platform 3 is movably disposed on the processing platform 2 and electrically coupled to the single-pulse electrical monitoring unit 1. The detachable jig 4 is movably disposed on the three-axis moving platform 3 and is configured to clamp a workpiece 8, such as a rod-tool. Under the control of the single-pulse electrical monitoring unit 1, the three-axis moving platform 3 drives the workpiece 8 clamped by the detachable jig 4 to move horizontally along the X-axis, Y-axis and Z-axis and rotate about the Z-axis. The reeling wire and electrical discharging unit 5 is disposed on the processing platform 2 and electrically coupled to the single-pulse electrical monitoring unit 1. The reeling wire and electrical discharging unit 5 provides the electrical discharge energy required for processing the workpiece 8 by electrical discharge machining (EDM) to thereby form a pointed conical electrode instrument. Under the control of the single-pulse electrical monitoring unit 1, the three-axis moving platform 3 enables the workpiece 8 clamped by the detachable jig 4 to approach the reeling wire and electrical discharging unit 5. Then, the single-pulse electrical monitoring unit 1 controls the three-axis moving platform 3 and the reeling and electrical discharging unit 5, such that the reeling wire and electrical discharging unit 5 processes the workpiece 8, such as a micro tool, by EDM. The single-pulse electrical discharging unit 6 is a metal slab disposed on the processing platform 2 and electrically coupled to the single-pulse electrical monitoring unit 1. The single-pulse electrical discharging unit 6 supplies the single-pulse electrical discharge energy required to process, by performing a one-pulse electro-discharge (OPED) process, the point of the workpiece 8 processed by the reeling wire and electrical discharging unit 5, such that the point of the workpiece 8 is turned into a sphere by an appropriate means of machining, such as forming. The optical measuring unit 7 is a white light interferometer disposed on the processing platform 2 and electrically coupled to the single-pulse electrical monitoring unit 1. The optical measuring unit 7 measures the workpiece 8, such as a micro spherical stylus, processed by OPED through the single-pulse electrical discharging unit 6. The single-pulse electrical monitoring unit 1 controls the three-axis moving platform 3, such that the workpiece 8 (i.e., the micro spherical stylus) which has been processed by OPED using the single-pulse electrical discharging unit 6 is moved to a position of the focal point of the optical measuring unit 7. Then, under the control of the single-pulse electrical monitoring unit 1, the optical measuring unit 7 measures the workpiece 8 (i.e., the micro spherical stylus) processed by OPED.

When the single-pulse electrical discharging unit 6 performs the OPED process on the point of the workpiece 8, such as a micro tool, the single-pulse electrical discharging unit 6 and the point of the workpiece 8 are spaced apart from each other by a distance of 1 μm to 2 μm, and the required electrical discharge energy falls within a range from 120 mJ to 200 mJ, such that the point of the workpiece 8 is melted, and a microsphere with a diameter from 50 μm to 80 μm is formed after the point of the workpiece 8 is cooled and solidified.

The reeling wire and electrical discharging unit 5 includes a power supply 51, a wire-releasing pulley 52, a processing pulley 53, a wire-receiving pulley 54 and a wire 55. The power supply 51 is electrically coupled to the single-pulse electrical monitoring unit 1 and includes a transistor/resistor/capacitor discharge circuit 511 and a resistor/capacitor discharge circuit 512 for supplying electric power to the wire 55. The wire 55 is a copper wire or any other wire capable of electrical conduction. The wire 55 is of a diameter from 0.1 mm to 0.2 mm. The wire 55 is wound along a winding path that passes the wire-releasing pulley 52, a notch 531 of the processing pulley 53, and the wire-receiving pulley 54. The wire 55 is configured to pass through the notch 531 to thereby process the workpiece 8 by EDM. The single-pulse electrical monitoring unit 1 switches between the transistor/resistor/capacitor discharge circuit 511 and the resistor/capacitor discharge circuit 512. The transistor/resistor/capacitor discharge circuit 511 performs a rough EDM process on the workpiece 8. The resistor/capacitor discharge circuit 512 performs a refined EDM process on the workpiece 8. The power supply 51 drives a motor (not shown) of the wire-receiving pulley 54, or, alternatively, drives a motor of the wire-receiving pulley 54 and the motor 521 of the wire-releasing pulley 52 to enable the wire 55 wound on the wire-releasing pulley 52 to be wound movably on the processing pulley 53 and then wound on the wire-receiving pulley 54.

When the reeling wire and electrical discharging unit 5 processes the workpiece 8 by EDM, the wire 55 passing through the notch 531 and the lateral side of the workpiece 8 are spaced apart from each other by a distance of 1 μm to 2 μm, and the required electrical discharge energy falls within a range from 120 mJ to 200 mJ, such that the workpiece 8 forms a pointed conical electrode instrument of a diameter ranging between 40 μm and 50 μm.

The optical measuring unit 7 includes a light emitting source 72, a lens 71, a charge-coupled device (CCD) 73 and an image capture unit 74. The light emitting source 72, the lens 71 and the CCD 73 are electrically coupled to the image capture unit 74. The image capture unit 74 is electrically coupled to the single-pulse electrical monitoring unit 1. The light emitting source 72 projects a light on the workpiece 8, such as the micro spherical stylus, and an image of the workpiece 8 is captured by the image capture unit 74 through the lens 71 and the CCD 73. Then, the image capture unit 74 sends the image of the workpiece 8 to the single-pulse electrical monitoring unit 1, such that the single-pulse electrical monitoring unit 1 measures and evaluates the quality of the workpiece 8.

The three-axis moving platform 3 includes an X-axis shifting unit 31, a Y-axis shifting unit 32 and a Z-axis shifting unit 33. The X-axis shifting unit 31 is movably disposed on the processing platform 2. The Y-axis shifting unit 32 is movably disposed on the X-axis shifting unit 31. The Z-axis shifting unit 33 is movably disposed on the Y-axis shifting unit 32. The detachable jig 4 is movably disposed on the Z-axis shifting unit 33. The X-axis shifting unit 31, the Y-axis shifting unit 32 and the Z-axis shifting unit 33 can be movably coupled together by a general mechanism such as a gear and a rack, a gear and a chain, or a slide block and a slide rail, etc. In addition, the workpiece 8 can be rotated with respect to the Z-axis shifting unit 33 by the detachable jig 4.

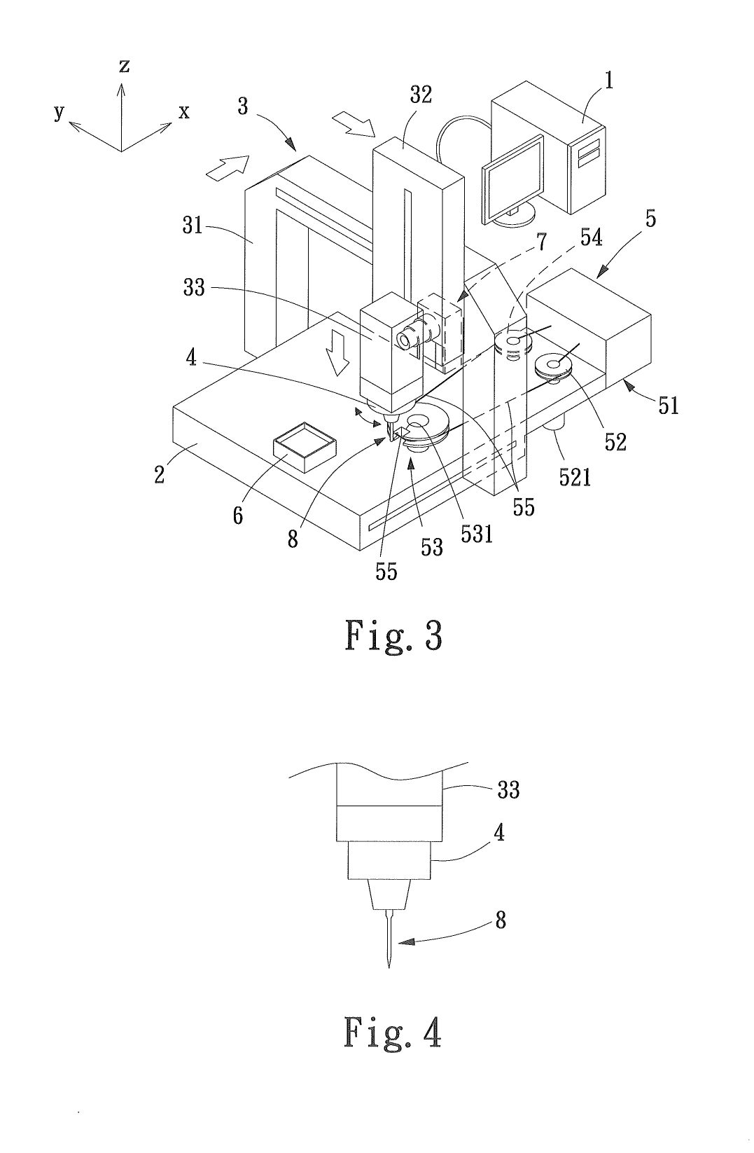

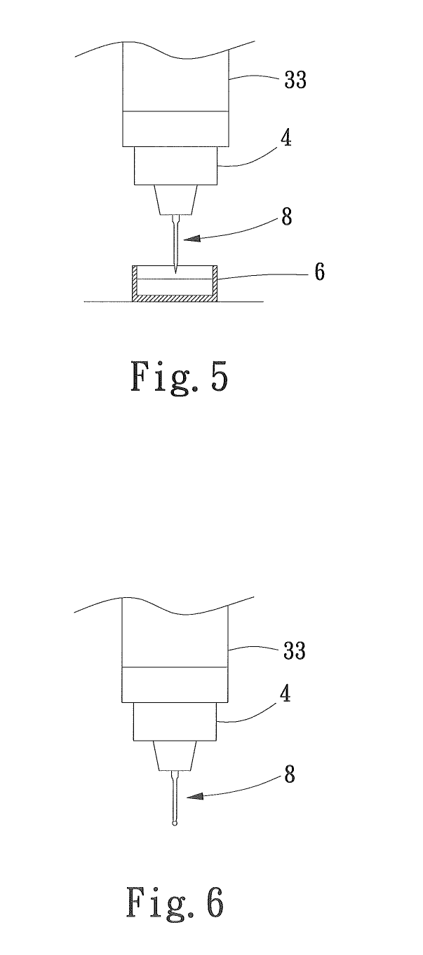

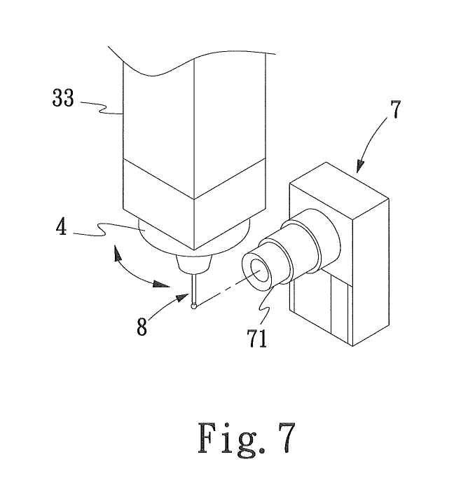

With reference to FIGS. 3 to 7 for a schematic view of processing a workpiece by EDM through a reeling wire and electrical discharging unit in accordance with a preferred embodiment of the present invention, there are shown a schematic view of the rod-tool processed by EDM, a schematic view of processing a micro tool by EDM through an electrical discharging unit in accordance with a preferred embodiment of the present invention, a schematic view of the micro tool processed by EDM, and a schematic view of measuring a micro spherical stylus by an optical measuring unit in accordance with a preferred embodiment of the present invention, respectively. Referring to FIG. 3, the workpiece 8, that is, the rod-tool, is movably disposed on the Z-axis shifting unit 33 by the detachable jig 4, and, under the control of the single-pulse electrical monitoring unit 1, the three-axis moving platform 3 drives the X-axis shifting unit 31 to move horizontally with respect to the processing platform 2, the Y-axis shifting unit 32 to move horizontally with respect to the X-axis shifting unit 31, and the Z-axis shifting unit 33 to move horizontally with respect to the Y-axis shifting unit 32, until the lateral side of the workpiece 8 approaches the wire 55 passing through the notch 531 of the processing pulley 53. Under the control of the single-pulse electrical monitoring unit 1, the reeling and electrical discharging unit 5 processes the workpiece 8 by EDM, and the Z-axis shifting unit 33 enables the rotation and vertical and horizontal displacement of the workpiece 8. Under the control of the single-pulse electrical monitoring unit 1, the transistor/resistor/capacitor discharge circuit 511 of the reeling and electrical discharging unit 5 performs a rough EDM process on the workpiece 8. Once the desired dimensions of the workpiece 8 are substantially obtained by the EDM process, the reeling wire and electrical discharging unit 5 will begin to perform a refined EDM process on the workpiece 8 by means of the resistor/capacitor discharge circuit 512 under the control of the single-pulse electrical monitoring unit 1. In so doing, the present invention takes less time to complete the EDM process than the prior art does. As shown in FIGS. 4 to 6, under the control of the single-pulse electrical monitoring unit 1, the three-axis moving platform 3 moves the workpiece 8 to above the single-pulse electrical discharging unit 6 after the workpiece 8 has been processed by EDM to thereby form a pointed conical electrode instrument. Afterward, under the control of the single-pulse electrical monitoring unit 1, the single-pulse electrical discharging unit 6 performs the OPED process on the workpiece 8 so as for a microsphere to be formed at the point of the workpiece 8. Finally, the workpiece 8 is turned into a micro spherical stylus. In FIG. 7, after the workpiece 8 is formed into the micro spherical stylus by OPED, the three-axis moving platform 3 moves the workpiece 8 to a position of the focal point of the optical measuring unit 7 under the control of the single-pulse electrical monitoring unit 1, and then the optical measuring unit 7 captures a planar image of the workpiece 8 under the control of the single-pulse electrical monitoring unit 1. After the image has been captured, the Z-axis shifting unit 33 of the three-axis moving platform 3 rotates the workpiece 8 by a specific angle under the control of the single-pulse electrical monitoring unit 1, and then the optical measuring unit 7 captures a planar image of the workpiece 8 under the control of the single-pulse electrical monitoring unit 1. The aforementioned procedure is repeated until the workpiece 8 finishes a rotation, and then the single-pulse electrical monitoring unit 1 can combine the planar images to form a 3D image of the workpiece 8, and record and evaluate the quality of the workpiece 8, such as, given different rotating angles of the workpiece 8, the deviation of the spherical center of the sphere of the workpiece 8 with respect to the axial center of the cylinder of the workpiece 8. The workpiece 8 is of the best quality when the axial center of the cylinder of the workpiece 8 passes through the spherical center of the sphere of the workpiece 8.

According to the present invention, a micro spherical stylus can be concurrently manufactured and evaluated on-one-machine with the same stylus manufacturing machine. After evaluating the micro spherical stylus, a worker replaces the detachable jig 4 by a contact probe (not shown) to clamp the micro spherical stylus, so that the original stylus manufacturing machine is turned into a coordinate measuring machine. During the measuring process, any deviation found can be used as a reference for the compensation or the correction to the measured data so as to reduce measurement errors and improve the accuracy of the measurements effectively.

In conclusion, the present invention adopts the reeling and electrical discharging unit, electrical discharging unit and optical measuring unit to manufacture a micro spherical stylus and evaluate the micro spherical stylus thus manufactured concurrently and on-one-machine, using the same stylus manufacturing machine, and turn the original stylus manufacturing machine into a coordinate measuring machine by using the micro spherical stylus. Obviously, the present invention complies with patent application requirements, and products derived from the present invention fully meet the present market requirements.

While the invention has been described by means of specific embodiments, numerous modifications and variations could be made thereto by those skilled in the art without departing from the scope and spirit of the invention set forth in the claims.

What is claimed is:

1. A micro spherical stylus manufacturing machine, comprising:
a single-pulse electrical monitoring unit;
a processing platform;
a three-axis moving platform movably disposed on the processing platform and electrically coupled to the single-pulse electrical monitoring unit;
a detachable jig movably disposed on the three-axis moving platform and configured to clamp a workpiece;
a reeling and electrical discharging unit disposed on the processing platform, electrically coupled to the single-pulse electrical monitoring unit, and configured to process the workpiece by electrical discharge machining (EDM) so as for the workpiece thus processed to form a pointed conical electrode instrument;
an electrical discharging unit disposed on the processing platform, electrically coupled to the single-pulse electrical monitoring unit, and configured to process by EDM the point of the workpiece processed by EDM through the reeling and electrical discharging unit so as for the point of the workpiece thus processed to form a sphere; and
an optical measuring unit disposed on the processing platform, electrically coupled to the single-pulse electrical monitoring unit, and configured to measure the workpiece processed by EDM through the electrical discharging unit.

2. The micro spherical stylus manufacturing machine of claim 1, wherein the electrical discharging unit and the point of the workpiece are spaced apart from each other by a distance of 1 μm to 2 μm, and a required electrical discharge energy falls within a range from 120 mJ to 200 mJ, such that the point of the workpiece forms the sphere of a diameter ranging between 50 μm and 80 μm.

3. The micro spherical stylus manufacturing machine of claim 2, wherein the optical measuring unit includes a light emitting source, a lens, a charge coupled device (CCD) and an image capture unit, wherein the light emitting source, the lens and the CCD are electrically coupled to the image capture unit, and the image capture unit is electrically coupled to the single-pulse electrical monitoring unit.

4. The micro spherical stylus manufacturing machine of claim 2, wherein the three-axis moving platform includes a X-axis shifting unit, a Y-axis shifting unit, and a Z-axis shifting unit, the X-axis shifting unit being movably disposed on the processing platform, the Y-axis shifting unit being movably disposed on the X-axis shifting unit, the Z-axis shifting unit being movably disposed on the Y-axis shifting unit, and the detachable jig being movably disposed on the Z-axis shifting unit.

5. The micro spherical stylus manufacturing machine of claim 2, wherein the reeling and electrical discharging unit includes a power supply, a wire-releasing pulley, a processing pulley, a wire-receiving pulley, and a wire, the power supply being electrically coupled to the single-pulse electrical monitoring unit and having a transistor/resistor/capacitor discharge circuit and a resistor/capacitor discharge circuit for supplying power to the wire, wherein the wire is wound on the wire-releasing pulley, passed through a notch of the processing pulley, and wound on the wire-receiving pulley, and the wire passing through the notch to process the workpiece by EDM.

6. The micro spherical stylus manufacturing machine of claim 5, wherein the wire passing through the notch and a lateral side of the workpiece are spaced apart from each other by a distance of 1 μm to 2 μm, and the required electrical discharge energy falls within a range from 120 mJ to 200 mJ, such that the workpiece forms a pointed conical electrode instrument of a diameter from 40 μm to 50 μm.

7. The micro spherical stylus manufacturing machine of claim 6, wherein the three-axis moving platform includes a X-axis shifting unit, a Y-axis shifting unit, and a Z-axis shifting unit, the X-axis shifting unit being movably disposed on the processing platform, the Y-axis shifting unit being movably disposed on the X-axis shifting unit, the Z-axis shifting unit being movably disposed on the Y-axis shifting unit, and the detachable jig being movably disposed on the Z-axis shifting unit.

8. The micro spherical stylus manufacturing machine of claim 6, wherein the optical measuring unit includes a light emitting source, a lens, a charge coupled device (CCD), and an image capture unit, wherein the light emitting source, the lens, and the CCD are electrically coupled to the image capture unit, and the image capture unit being electrically coupled to the single-pulse electrical monitoring unit.

9. The micro spherical stylus manufacturing machine of claim 5, wherein the optical measuring unit includes a light emitting source, a lens, a charge coupled device (CCD), and an image capture unit, wherein the light emitting source, the lens, and the CCD are electrically coupled to the image capture unit, the image capture unit being electrically coupled to the single-pulse electrical monitoring unit.

10. The micro spherical stylus manufacturing machine of claim 5, wherein the three-axis moving platform includes a X-axis shifting unit, a Y-axis shifting unit, and a Z-axis shifting unit, the X-axis shifting unit being movably disposed on the processing platform, the Y-axis shifting unit being movably disposed on the X-axis shifting unit, the Z-axis shifting unit being movably disposed on the Y-axis shifting unit, and the detachable jig being movably disposed on the Z-axis shifting unit.

11. The micro spherical stylus manufacturing machine of claim 1, wherein the reeling and electrical discharging unit includes a power supply, a wire-releasing pulley, a processing pulley, a wire-receiving pulley, and a wire, wherein the power supply is electrically coupled to the single-pulse electrical monitoring unit and includes a transistor/resistor/capacitor discharge circuit and a resistor/capacitor discharge circuit for supplying electricity to the wire respectively, the wire being wound on the wire-releasing pulley, passed through a notch of the processing pulley, and wound on the wire-receiving pulley, wherein the wire passing through the notch is configured to process the workpiece by EDM.

12. The micro spherical stylus manufacturing machine of claim 11, wherein the wire wound through the notch and a lateral side of the workpiece are spaced apart from each other by a distance of 1 μm to 2 μm, and a required electrical discharge energy falls within a range from 120 mJ to 200 mJ, such that the workpiece forms a pointed conical electrode instrument of a diameter from 40 μm to 50 μm.

13. The micro spherical stylus manufacturing machine of claim 12, wherein the optical measuring unit includes a light emitting source, a lens, a charge coupled device (CCD), and an image capture unit, wherein the light emitting source, the lens, and the CCD are electrically coupled to the image capture unit, the image capture unit being electrically coupled to the single-pulse electrical monitoring unit.

14. The micro spherical stylus manufacturing machine of claim 12, wherein the three-axis moving platform includes a X-axis shifting unit, a Y-axis shifting unit, and a Z-axis shifting unit, the X-axis shifting unit being movably disposed on the processing platform, the Y-axis shifting unit being movably disposed on the X-axis shifting unit, the Z-axis shifting unit being movably disposed on the Y-axis shifting unit, and the detachable jig being movably disposed on the Z-axis shifting unit.

15. The micro spherical stylus manufacturing machine of claim 11, wherein the optical measuring unit includes a light emitting source, a lens, a charge coupled device (CCD), and an image capture unit, wherein the light emitting source, the lens, and the CCD are electrically coupled to the image capture unit, the image capture unit being electrically coupled to the single-pulse electrical monitoring unit.

16. The micro spherical stylus manufacturing machine of claim 11, wherein the three-axis moving platform includes a X-axis shifting unit, a Y-axis shifting unit, and a Z-axis shifting unit, the X-axis shifting unit being movably disposed on the processing platform, the Y-axis shifting unit being movably disposed on the X-axis shifting unit, the Z-axis shifting unit being movably disposed on the Y-axis shifting unit, and the detachable jig being movably disposed on the Z-axis shifting unit.

17. The micro spherical stylus manufacturing machine of claim 1, wherein the optical measuring unit includes a light emitting source, a lens, a charge coupled device (CCD), and an image capture unit, wherein the light emitting source, the lens, and the CCD are electrically coupled to the image capture unit, the image capture unit being electrically coupled to the single-pulse electrical monitoring unit.

18. The micro spherical stylus manufacturing machine of claim 1, wherein the three-axis moving platform includes a X-axis shifting unit, a Y-axis shifting unit, and a Z-axis shifting unit, the X-axis shifting unit being movably disposed on the processing platform, the Y-axis shifting unit being movably disposed on the X-axis shifting unit, the Z-axis shifting unit being movably disposed on the Y-axis shifting unit, and the detachable jig being movably disposed on the Z-axis shifting unit.
